(19) United States
(12) Patent Application Publication
(10) Pub. No.: US 2024/0128471 A1
(43) Pub. Date: Apr. 18, 2024

(54) UV-OZONE TREATED ZINC OXIDE NANOSTRUCTURED ELECTROCATALYST SYSTEM AND METHOD

(71) Applicant: Purdue Research Foundation, West Lafayette, IN (US)

(72) Inventor: Wenzhuo Wu, West Lafayette, IN (US)

(73) Assignee: Purdue Research Foundation, West Lafayette, IN (US)

(21) Appl. No.: 18/379,738

(22) Filed: Oct. 13, 2023

Related U.S. Application Data
(60) Provisional application No. 63/416,021, filed on Oct. 14, 2022.

(51) Int. Cl. H01M 4/90; H01M 4/88; H01M 8/1011

(52) U.S. Cl. CPC H01M 4/9016; H01M 4/8882; H01M 4/9075; H01M 8/1011

(57) ABSTRACT

The electrocatalyst system that is configured to oxidize a methanol molecule using piezo-electrocatalysis includes a substrate and a piezoelectric semiconductor. The piezoelectric semiconductor is coupled to the substrate. The piezoelectric semiconductor includes a nanostructured semiconducting zinc oxide (ZnO) catalyst. The nanostructured semiconducting zinc oxide catalyst is characterized by a UV-ozone (UV-O₃) treatment process. The electrocatalyst system may be provided in a methanol fuel cell.

### CROSS REFERENCE TO RELATED APPLICATIONS

This application claims the priority benefit of U.S. Provisional Patent application No. 63/416,021, filed Oct. 14, 2022, the contents of which is incorporated herein by reference in its entirety.

### GOVERNMENT RIGHTS

This invention was made with government support under DE-AC07-05ID14517 awarded by the Department of Energy. The government has certain rights in the invention.

### FIELD

The disclosure generally relates to electrocatalysts and, more particularly, to piezo-electrocatalytic methanol oxidation systems.

### INTRODUCTION

This section provides background information related to the present disclosure which is not necessarily prior art.

Fuel cells, which convert chemical energy into electrical energy, have shown promise as one of the most prominent clean energy technologies due to their high efficiency and lower greenhouse gas emissions. The use of fuel cell-based products to power automobiles, submarines, space missions, and numerous other applications has garnered greater interest. The polymer electrolyte membrane fuel cells (PEMFC) that use pure hydrogen as fuel boast high energy conversion efficiencies among many types of fuel cells. However, hydrogen extraction, storage, transportation, and management continue to encounter substantial obstacles. In contrast, direct methanol fuel cells (DMFCs) employing methanol as the liquid fuel are compatible with existing petroleum distribution networks. The appealing properties of methanol (e.g., energy-dense, reasonably stable, liquid state) at room temperature and atmospheric pressure make storage, transportation, and energy conversion safer and more convenient. Due to its abundant sources, enormous market volume, and sustainable development of the entire industry chain, methanol has been gradually recognized as an ideal clean and renewable fuel in the global industry. As a result, it has been used as a source of increasing importance in electric vehicles and portable electronic devices. Nonetheless, DMFCs continue to suffer from slow anode methanol oxidation reaction (MOR) kinetics, which directly affects methanol anodic oxidation speed, exacerbates anodic polarization loss, and decreases exchange current density. Searching for efficient and reliable anodic MOR electrocatalysts is therefore vital for the cost-effective application and deployment of DMFCs.

To this end, intensive efforts have been devoted to the development of high-efficiency electrocatalysts in order to improve MOR kinetics effectively. Noble metal catalysts (e.g., those based on Pt or Pd) have exhibited the highest catalytic activity for MOR to date. Nevertheless, these catalysts' high cost and scarcity and their vulnerability to poisoning during the MOR process have impeded their widespread commercial deployment and utilization. To address the above challenges, many efforts have been made to explore effective MOR electrocatalysts based on earth-abundant transition metal oxides (TMOs). TMOs have semiconducting properties, in which the d orbital of the metal cation easily loses or attracts electrons, forming intermediate products and reducing the activation energy of the catalytic reactions. In addition, TMOs boast strong poisoning tolerance, and their photosensitivity and heat sensitivity are more conducive to the modulation of catalyst performance. However, the intrinsic catalytic activity of TMOs still lags behind that of platinum-based catalysts. Conductivity and intrinsic activity are the two crucial features in high-performance TMOs catalysts. Incorporating additional metals (e.g., Pt, Pd, or the transition metals Co, Cu, and Mn) into TMOs-based MOR electrocatalysts is one technique for enhancing the catalytic activity of TMOs. However, theoretical studies have demonstrated that the changes in the electronic structure of the TMO catalyst caused by the charge transfer between the bimetallic atoms, would result in an increase in the electron density on the d orbital of the catalyst and a reduction in the charge transfer from the methanol molecule to the catalyst, resulting in a decrease in overall MOR catalytic efficiency. Furthermore, by introducing a porous structure into the electrocatalyst, fast and efficient charge transfer was achieved via a porous framework with a high specific surface area. However, this does not eliminate the shortcomings of traditional MOR catalysts, which are susceptible to oxidation, reduction, decomposition, or poisoning. Catalyst support, such as carbon nanofiber or graphene, which can be prepared into specific shapes and can improve the microstructure of the supported catalyst, is commonly incorporated in TMOs-based MOR catalysts. The primary role of the catalyst support is to improve the morphological structure of the catalyst, as well as to disperse and support the main catalyst, thereby improving the effective surface area and mechanical stability of the catalyst, extending its service life, and decreasing its cost. In such designs, however, if TMO nanomaterials are poorly dispersed and weakly adsorbed on a catalyst support, the tendency of these materials to agglomerate will impede their potential applications. Conversely, if the TMO nanoparticles are firmly attached to the catalyst support, the active sites of the catalyst are easily obstructed. In addition, excessive anchoring makes support materials and catalysts more susceptible to excessive oxidation and corrosion in the hostile working environment of fuel cells, resulting in structural failure and a decline in electrochemical performance.

Accordingly, there is a continuing need for an electrocatalyst system with enhanced efficiency that may also enable methanol oxidation. Desirably, the electrocatalyst system may be easily and more economically manufactured than known electrocatalyst systems.

### SUMMARY

In concordance with the instant disclosure, the electrocatalyst system has enhanced efficiency over known electrocatalyst devices by elucidating the charge transfer between mechanically-deformed ZnO nanostructures and methanol molecules. Desirably, the electrocatalyst system may be easily and more economically manufactured than known electrocatalyst devices.

The electrocatalyst system configured to oxidize methanol using piezo-electrocatalysis includes a substrate and a piezoelectric semiconductor. The piezoelectric semiconductor may be coupled to the substrate, The piezoelectric semiconductor may include a nanostructured semiconducting zinc oxide (ZnO) catalyst. The nanostructured semiconducting zinc oxide catalyst may be treated with UV-ozone (UV-O₃). In a specific example, the electrocatalyst system may be provided in a methanol fuel cell.

Various ways of manufacturing the electrocatalyst system are provided. For instance, a method may include a step of providing a substrate. The substrate may be constructed from a conductive material, such as a metal material and/or graphite. In a more specific example, the substrate may include an indium tin oxide substrate. In an even more specific example, the substrate may include an indium tin oxide coated polyethylene terephthalate film. Next, the method may include disposing the substrate in a seed solution. It is also contemplated for the seed solution to be disposed onto the substrate. The seed solution may include a zinc salt such as zinc acetate, zinc nitrate, and/or zinc chloride. In a more specific example, the seed solution may include zinc acetate dihydrate. The seed solution may be configured to produce a ZnO seed layer on the substrate. In some circumstances, the method may include a step of annealing the substrate. In a specific example, the substrate may be annealed at around eight-five degrees Celsius. In a more specific example, the substrate may be disposed in the seed solution and annealed multiple times. In an even more specific example, the substrate may undergo a final annealing cycle at around two-hundred fifty degrees Celsius for around twenty minutes. After the substrate is annealed, a ZnO seed layer may be coupled to the substrate. Then, the substrate with the ZnO seed layer may be disposed into a growth solution. The growth solution may be configured to form a semiconducting nanostructured ZnO catalyst on the substrate. In a specific example, the growth solution may include zinc nitrate and/or hexamethylenetetramine to form ZnO NRs. In a separate, specific example, the growth solution may include zinc chloride and potassium chloride to form ZnO NSs. Afterwards, the semiconducting nanostructured ZnO catalyst disposed on the substrate may be treated with a UV-ozone (UV-O3), thereby manufacturing the electrocatalyst system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a top plan view of an SEM image of nanorods (NRs) that may be utilized as a zinc oxide (ZnO) catalyst of an electrocatalyst system, according to one embodiment of the present disclosure;

FIG. 1B is a cross-sectional view of an SEM image of NRs, as shown in FIG. 1A, according to one embodiment of the present disclosure;

FIG. 1C is a top plan view of an SEM image of ZnO nanosheets (NSs) that may be utilized as a ZnO catalyst of an electrocatalyst system, according to one embodiment of the present disclosure;

FIG. 1D is an AFM image of ZnO NSs that may be utilized as a ZnO catalyst of an electrocatalyst system, according to one embodiment of the present disclosure;

FIG. 1E is a line graph of XRD patterns of ZnO NSs and NRs that may be utilized as a ZnO catalyst of an electrocatalyst system, according to one embodiment of the present disclosure;

FIG. 2(a) is a schematic illustration of an experimental setup for piezoelectric effect enhanced electrocatalytic MOR, FIG. 2(b) is a line graph illustrating CV curves of deformed ZnO NSs and NRs in 0.1 M KOH solution with or without 0.5 M methanol (scan rate is 50 mV s−1), FIG. 2(c) is a line graph illustrating the relationship between the anodic peak current and the square root of the scan rate (Iₚₐ−v^{1/2}) in 0.1 M KOH solution, FIG. 2(d) is a line graph illustrating the CV curves of deformed or undeformed ZnO NSs and NRs in 0.5 M methanol/0.1 M KOH, FIG. 2(e) is a line graph illustrating Tafel plots of various ZnO samples in 0.5 M methanol/0.1 M KOH, and FIG. 2(f) is a line graph illustrating frequency-phase curves of various ZnO samples in 0.5 M methanol/0.1 M KOH, according to one embodiment of the present disclosure;

FIG. 3 (a) includes front elevational views of water contact angle images of undeformed ZnO NRs (left) and NSs (right) under 0, 20, 40, 60 s UV-O₃ treatment, FIG. 3(b) is a line graph illustrating the relationship between peak current (Ip) and square root of the scan rate (v^{1/2}) for deformed ZnO NRs (left) and NSs (right) in 1.0 mM [Fe(CN)₆]^{3-/4-} solution. FIG. 3(c) is a bar graph illustrating MOR performance of deformed ZnO NRs under different UV-O₃ treatment time (10-60 s), FIG. 3(d) is a bar graph illustrating MOR performance of deformed NSs under different UV-O₃ treatment time (10-60 s), according to one embodiment of the present disclosure;

FIG. 4(a) is a bar chart illustrating a current density change rate of electrocatalytic MOR by deformed ZnO NRs (red) and NSs (blue) in the presence and absence of BQ (superoxide radical scavengers), TBA (hydroxyl radical scavengers) and EDTA (holes scavengers). FIG. 4(b) is a front perspective view of a 3D schematic diagrams of a deformed ZnO NR with illustrated distribution of the piezoelectric potential field, FIG. 4(c) is a front perspective view of a 3D schematic diagrams of a deformed ZnO NS with illustrated distribution of the piezoelectric potential field, FIG. 4(d) is a mechanistic scheme of the electrocatalytic MOR enhanced by the piezoelectric effect. (Plpz: piezoelectric polarization field), according to one embodiment of the present disclosure;

FIG. 5 is a line graph illustrating a line scan along the red line, as shown in FIG. 1 (d), further depicting a lateral size of several micrometers and thickness of 105 nm, according to one embodiment of the present disclosure;

FIG. 6 is a right-side elevational view of a schematic diagram for estimating strain in ZnO NSs or NRs, according to one embodiment of the present disclosure;

FIG. 7(a) is a line graph illustrating CV curves of undeformed ZnO NRs, FIG. 7(b) is a line graph illustrating CV curves of deformed ZnO NRs, FIG. 7(c) is a line graph illustrating CV curves of undeformed ZnO NSs, and FIG. 7(d) is a line graph illustrating CV curves of deformed ZnO NSs in 0.1 M KOH solution at potential sweep rates of 10, 20, 50, 70, 100, 120 and 150 mV/s, wherein all samples are treated with UV-O3 40 s, according to one embodiment of the present disclosure;

FIG. 8(a) is a line graph illustrating a linear sweep voltammetry curve of deformed ZnO NRs measured in 0.1 M KOH solution with and without 0.5 M methanol at a scan rate of 20 mV/s, and FIG. 8(b) is a line graph illustrating a linear sweep voltammetry curve of deformed ZnO NSs measured in 0.1 M KOH solution with and without 0.5 M methanol at a scan rate of 20 mV/s, according to one embodiment of the present disclosure;

FIG. 9 is a chronoamperometry graph of deformed ZnO NRs in 0.1 M KOH/0.5 M methanol solution at the potential of 0.5 V vs. Ag/AgCl, according to one embodiment of the present disclosure;

FIG. 10(a) is a line graph of a CV curve of deformed ZnO NRs untreated with UV-O₃ (40 s), FIG. 10(b) is a line graph of a CV curve of deformed ZnO NRs treated with UV-O₃ (40 s), FIG. 10(c) is a line graph of a CV curve of deformed ZnO NSs untreated with UV-O₃ (40 s) in 1 mM [Fe(CN)₆]^{3-/4-} solution at scan rates of 100 mV/s, and FIG. 10(d) is a line graph of a CV curve of deformed ZnO NSs treated with UV-O₃ (40 s) in 1 mM [Fe(CN)₆]^{3-/4-} - solution at scan rates of 100 mV/s., according to one embodiment of the present disclosure;

FIG. 11 is a box diagram illustrating the components of the electrocatalyst system, according to one embodiment of the present disclosure; and

FIG. 12 is a flow chart of a method for manufacturing the electrocatalyst system, according to one embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Leveraging the mechanically induced piezoelectric polarization, piezocatalysis emerges as a viable mechanism for enhancing the efficiency of catalytic processes. Nanostructured, catalytically active, rationally designed piezoelectric semiconductors can achieve high-performance catalysts for various applications using cost-effective electrocatalytic pathways, such as mechanical stimuli. The electrocatalyst system of the present disclosure is a cost-effective, high-performance piezo-electrocatalyst for anodic methanol oxidation, which is crucial for the practical application and deployment of direct methanol fuel cells in a variety of emerging clean energy technologies. Synthesized wurtzite Zinc Oxide (ZnO) nanorods and nanosheets were treated with UV-O₃ to characterize and compare their efficacy for piezo-electrocatalytic methanol oxidation. The generation of piezoelectric polarization charges in nanostructured semiconducting ZnO catalysts significantly increased their electrocatalytic performance. By elucidating the charge transfer between mechanically deformed ZnO nanostructures and methanol molecules, the underlying mechanism for the piezo-electrocatalytic process for methanol oxidation was determined. The facile synthesis of high-quality ZnO nanostructures enables low-cost, scalable manufacture and direct integration into electrocatalysts whose performance could be enhanced by harvesting mechanical energy that would otherwise be wasted in the working environment.

ZnO has been explored for electrocatalysis due to its semiconducting properties, low cost, and good chemical stability. Wurtzite ZnO nanostructures also exhibit confinement-enhanced piezoelectric properties, hence enabling ZnO nanostructures (e.g., nanowires, nanorods) to serve as material platforms for exploring the emerging piezo-electrocatalysis. By modifying the morphology, size, and external force stimuli of the ZnO catalysts, the efficiency of piezo-electrocatalysis in ZnO nanostructures can be considerably improved by the strain-induced piezoelectric field. In addition, the piezoelectric effect leads to the creation of free radicals on the surface of ZnO, which could participate in the methanol oxidation reaction and mitigate the issues of oxidation, poisoning, degradation, and corrosion that plague conventional MOR catalysts. The exceptional mechanical properties of ZnO nanostructures further enhance the strain tunability of ZnO catalysts, which is unattainable for bulk piezoelectrics, hence boosting the performance of ZnO piezo-electrocatalysis driven by weak mechanical stimuli. Advantageously, ZnO nanostructures with holistically designed and engineered piezoelectric semiconductor properties may alleviate the challenges known MOR catalysts face via simple and cost-effective pathways.

The electrocatalyst system of the present disclosure is a high-efficiency, cost-effective MOR catalyst via piezo-electrocatalysis with dramatically enhanced catalytic efficiency. The piezoelectric polarization produced by nanostructured semiconducting ZnO catalysts may significantly improve MOR efficiency. To evaluate and demonstrate the efficacy of piezo-electrocatalysis on methanol oxidation, well-defined ZnO nanosheets (ZnO NSs) and nanorods (NRs) were synthesized. In addition, a facile UV-ozone (UV-O₃) treatment was introduced to improve the hydrophilicity of the material surface and further boost the catalytic performance. The MOR anodic current density of the deformed ZnO NRs increased to 7.0 μA cm⁻² from 0.3 μA cm⁻² in the undeformed ZnO NRs, whereas it grew to 6.3 μA cm⁻² from 4.0 μA cm⁻² in ZnO NSs with applied strains. The piezo-electrocatalytic MOR system can recover ambient mechanical energy that would otherwise be wasted (such as wave energy, tidal energy, wind energy, and even human kinetic energy, etc. in order to improve the efficiency of methanol oxidation. The hydrothermal synthesis of related ZnO nanostructures promises low-cost, scalable manufacture of MOR catalysts with excellent cost-effectiveness.

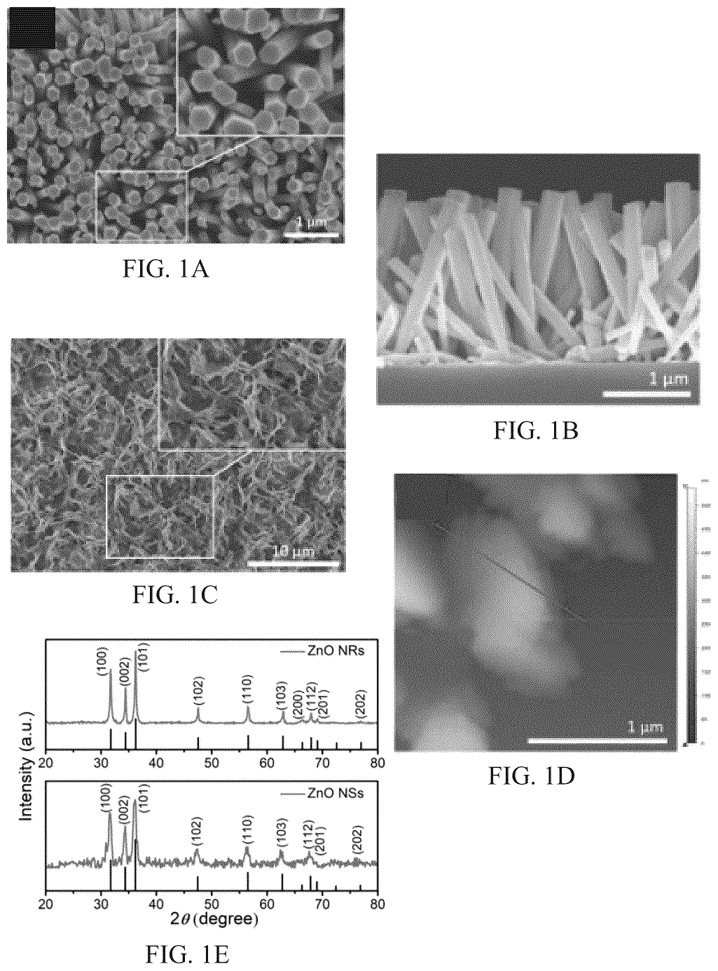

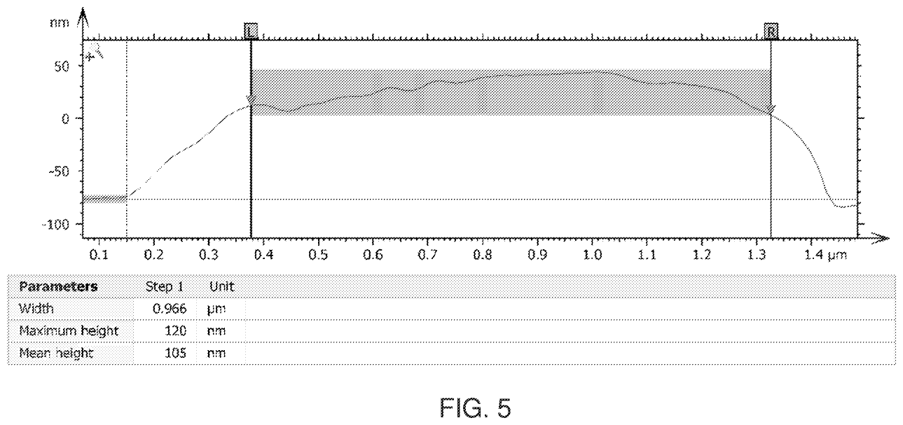

In certain circumstances, the piezoelectric ZnO nanosheets (ZnO NSs) and ZnO nanorods (ZnO NRs) were synthesized by a facile hydrothermal method. The growth solutions of ZnO NSs and NRs may include zinc chloride and/or nitrate components. Without being bound to any particular theory, it is believed that the introduction of Cl— may restrict growth along the direction, favoring ZnO nanosheets' growth. Scanning electron microscopy (SEM) was used to characterize the morphologies of ZnO NSs and NRs. As shown in FIG. 1(a), ZnO NRs exhibit a typical hexagonal rod-like morphology. The magnified SEM image shows that ZnO NRs have a uniform diameter of approximately 200 nm. The SEM cross-sectional image, as shown in FIG. 1(b), revealed that the majority of ZnO NRs are aligned vertically with a length of 2 μm. The SEM and atomic force microscopy (AFM) images of ZnO nanosheets, as shown in FIGS. 1(c, d), indicated their sheet-like morphology. AFM studies revealed that the thickness of ZnO NSs ranges from 95 to 120 nm, with an average thickness of approximately 105 nm and a side length of 1-2 μm., as shown in FIG. 5. In addition, X-ray diffraction (XRD) examination was conducted to assess the synthesized samples'structure. All the diffraction peaks of ZnO NRs could be indexed to the hexagonal wurtzite phase of ZnO (JCPDS Card No. 36-1451). Sharp diffraction peaks showed a high degree of crystallinity. The XRD spectra of ZnO NSs is consistent with the typical wurtzite ZnO crystalline phase (JCPDS Card No. 80-0074), and the weaker and broader XRD peaks indicated the small sizes of ZnO NSs. As anticipated, both samples exhibited a preferred orientation along the (100), (002), and (101) planes. ZnO NRs exhibited peaks with greater intensity than ZnO NSs. Due to the non-centrosymmetric structure of the wurtzite phase, ZnO NRs and NSs are expected to exhibit piezoelectric properties.

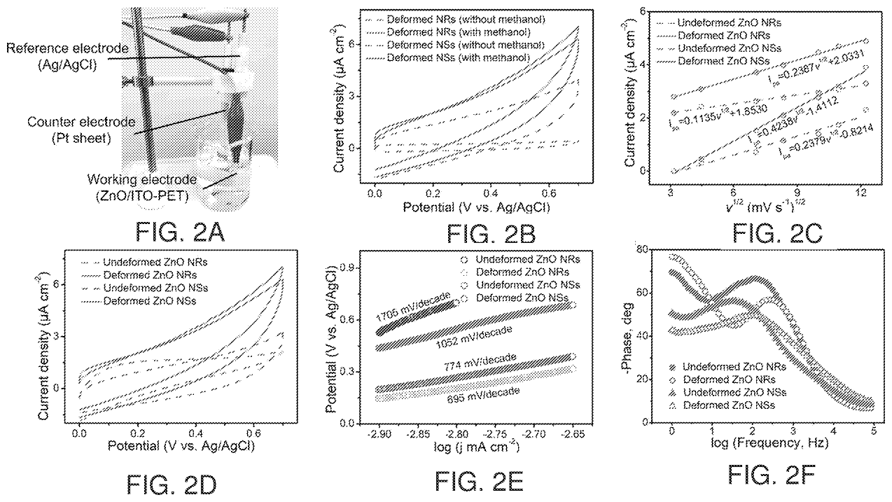

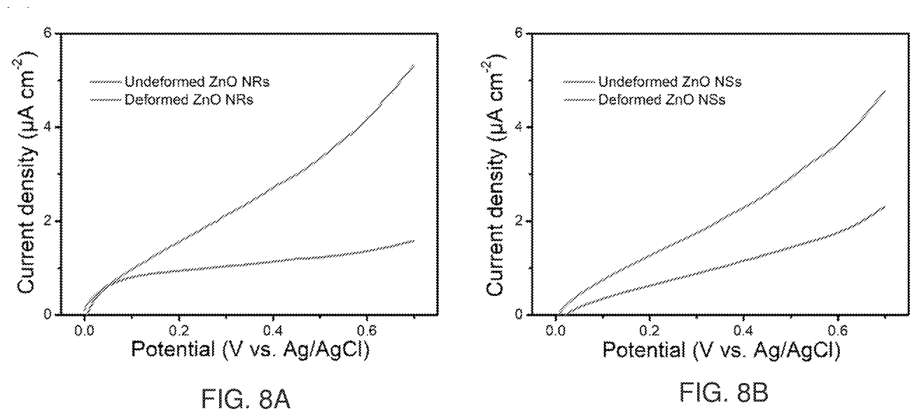

As a specific, nonlimiting example, FIG. 2(a) depicts the experimental setup for the piezo-electrocatalytic oxidation of methanol. Two morphologies of ZnO were hydrothermally synthesized on indium tin oxide-coated polyethylene terephthalate (ITO-PET) substrates. The applied strain can be tuned by controlling the bending curvature of the ZnO/ITO-PET substrate. To investigate the feasibility and efficacy of the piezoelectric effect on the electrocatalytic MOR, electrochemical measurements using ZnO nanomaterials-modified ITO-PET electrode treated with UV-O₃ were conducted. When the ITO-PET substrate is bent, the overall mechanical properties are dictated by the substrate, and tensile/compressive strain is formed in the ZnO nanomaterial on the substrate. The efficacy of deformed ZnO NRs and NSs (0.4% strain) for electrocatalytic MOR was first evaluated. To investigate the catalytic feasibility of the deformed ZnO on MOR, the CV curves of deformed ZnO catalysts were monitored at a scan rate of 50 mV·s⁻¹ in 0.1 M KOH solutions with and without 0.5 M methanol. After the addition of methanol, the anodic current density of deformed ZnO NRs rose (from 0.3 mA·cm⁻² (without methanol) to 7.0 mA·cm⁻² (with methanol)), conclusively demonstrating the high catalytic activity of MOR, as shown in FIG. 2(b). However, following the addition of methanol, the anodic current density of deformed NSs marginally increased (from 4.0 (without methanol) to 6.3 (with methanol) mA·cm⁻²), demonstrating a moderate catalytic activity of deformed ZnO NSs for MOR, as shown in FIG. 2(b). FIG. 8 depicts the relevant linear sweep voltammetry (LSV) curves.

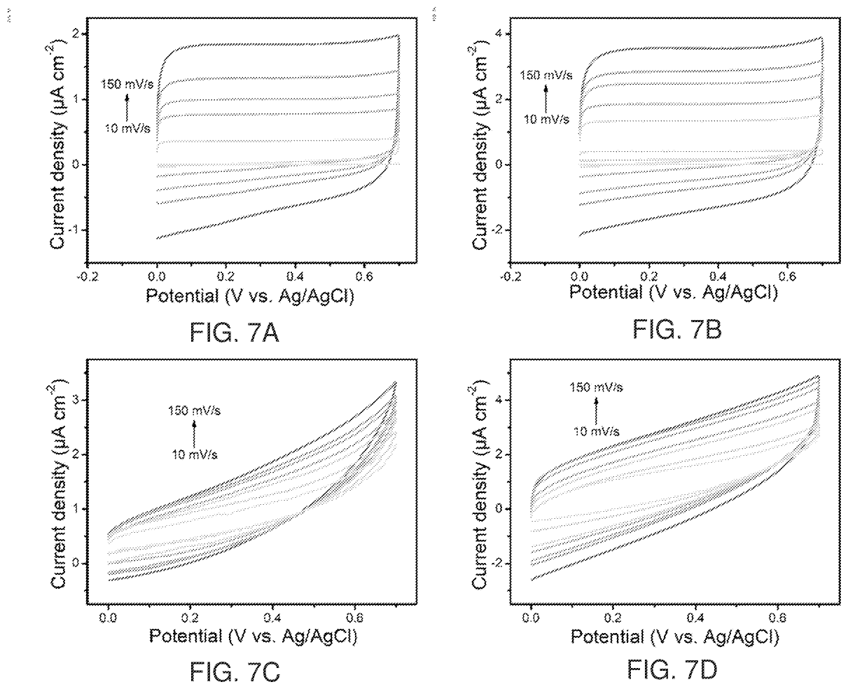

With continued reference to the non-limiting example, the diffusivity of OH— on the undeformed or deformed catalyst surface to reveal methanol's adsorption and desorption rates was then investigated. The cyclic voltammetry (CV) curves of all undeformed or deformed (0.4% strain) ZnO NSs and NRs were recorded in 0.1 M KOH solution under different scan rates, as shown in FIG. 7. FIG. 2(c) illustrates the relationship between the anodic peak current densities (Ipa) and the square roots of the scan rate (v^{1/2}). The slopes of Iₚₐ-v^{1/2} curves for the deformed and undeformed ZnO NRs were calculated to be 0.4238 and 0.2379, while 0.2387 for deformed ZnO NSs and 0.1135 for undeformed ZnO NSs. The larger slope value for deformed samples indicated that the diffusion ability of OH⁻ on the catalyst surface is superior to that of undeformed samples, which is advantageous for accelerating the adsorption and desorption of methanol molecules on the catalyst surface, thereby enhancing methanol oxidation.

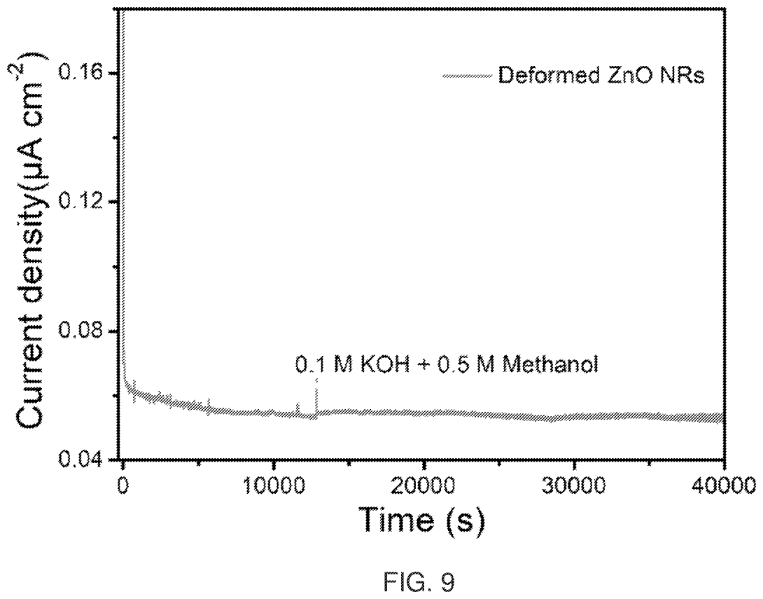

In a specific example, to demonstrate the enhancement by the piezoelectric effect on MOR, deformed and undeformed ZnO materials were used as catalysts to participate in MOR, respectively. As shown in FIG. 2(d), the electrocatalytic MOR performance of the deformed ZnO NSs and NRs was superior to that of the undeformed ZnO NSs and NRs, respectively. ZnO not only serves as a semiconductor to offer active sites to accelerate the electro-oxidation reaction of methanol, but it also generates radicals through piezoelectric charges on the catalyst surface to enhance the methanol oxidation, enabling synergy between electrocatalysis and piezocatalysis. As shown in FIG. 2(d), a significant current density change was observed between deformed (7.0 μA cm⁻²) and undeformed (2.1 μA cm⁻²) ZnO NRs to methanol oxidation. While for ZnO NSs, the current density increased from 3.2 μA cm⁻² (undeformed) to 6.3 μA cm⁻² (deformed). ZnO nanorods structures exhibit a stronger piezo-electrocatalytic enhancement for MOR, possibly due to the more significant piezoelectric potential induced in ZnO NRs. LSV curves and corresponding Tafel plots were used to further evaluate the MOR catalytic activity of these catalysts. The Tafel slopes of deformed NRs and deformed NSs are 695 and 774 mV dec⁻¹, substantially lower than those of undeformed ZnO NRs (1705 mV dec⁻¹) and undeformed ZnO NSs (1052 mV dec⁻¹), as shown in FIGS. 2(e) and 8, revealing that the deformation-induced piezoelectric polarization is more conducive to accelerating the kinetics of methanol oxidation. Additionally, electrochemical impedance spectroscopy (EIS) was utilized to assess the kinetics of MOR. Adsorption of methanol molecules alters the complex electrical impedance, specifically the phase shift between the input voltage and output current. As shown in FIG. 2(f), the phase peaks in the plot correspond to the reaction between methanol and OH⁻, and the phase peaks of ZnO NSs or NRs after deformation are smaller and shift to high frequencies than the cases without deformation in the frequency range of 0-100,000 Hz. This demonstrates that the interfacial charge transfer resistance in deformed ZnO is much smaller in the MOR process, leading to an acceleration of the MOR kinetics, which is attributed to the deformation-induced piezoelectric effect. The small charge transfer resistance indicates that methanol molecules adsorb and desorb rapidly on the ZnO surface. In addition to catalytic activity, catalytic stability is crucial to MOR reliability and long-term application. As illustrated in FIG. 9, the chronoamperometric measurement was evaluated by continuously scanning for 40,000 s at 0.5 V in a 0.5 M methanol solution containing 0.1 M KOH. Advantageously, even after long-term testing, there is only a slight decline in anodic current density, demonstrating the exceptional catalytic stability of deformed ZnO NRs to MOR. These characteristics show the potential of ZnO piezo-electrocatalysts as anode material for fuel cells.

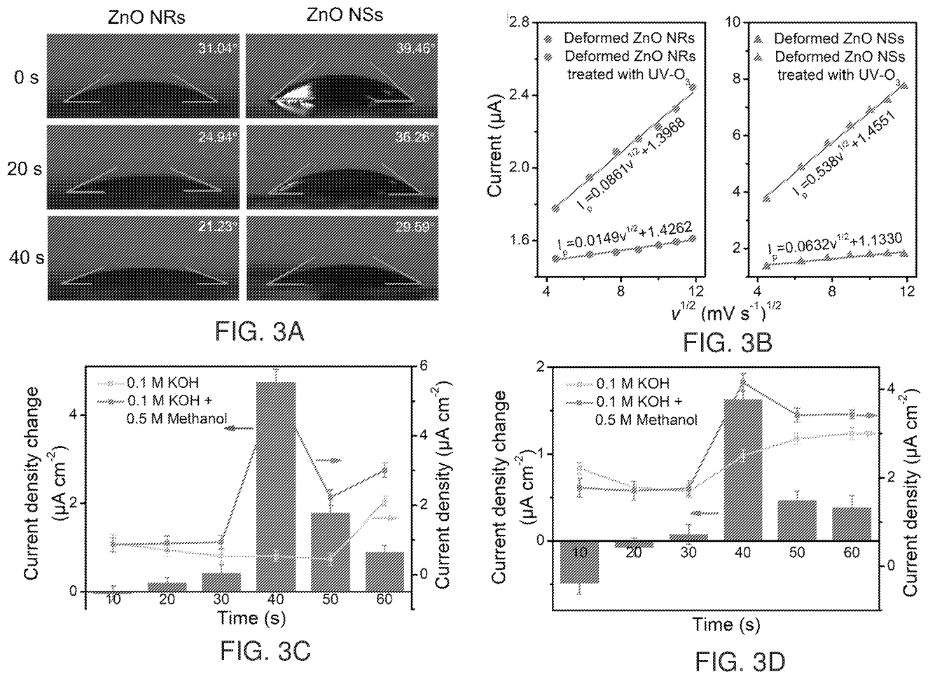

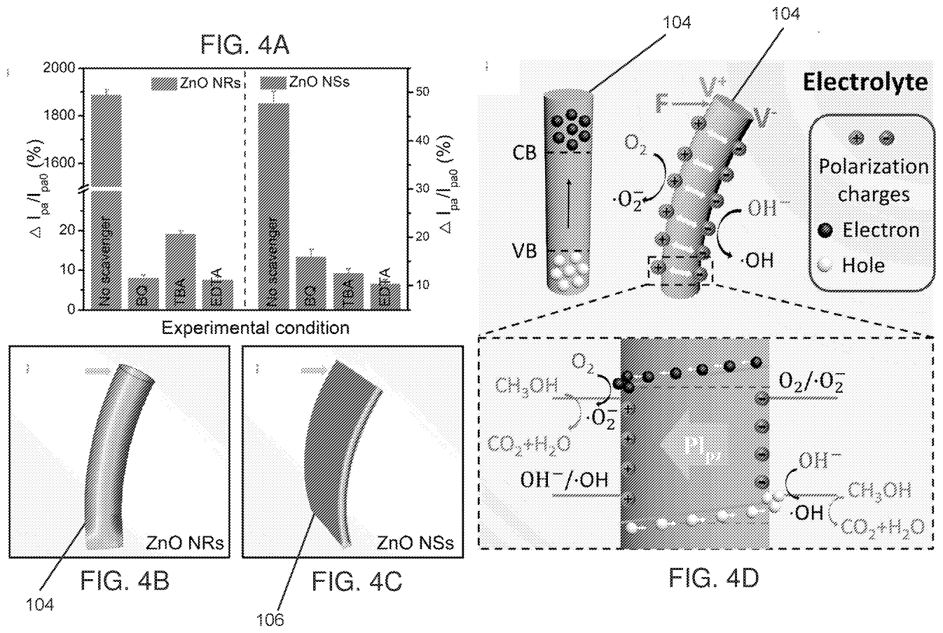

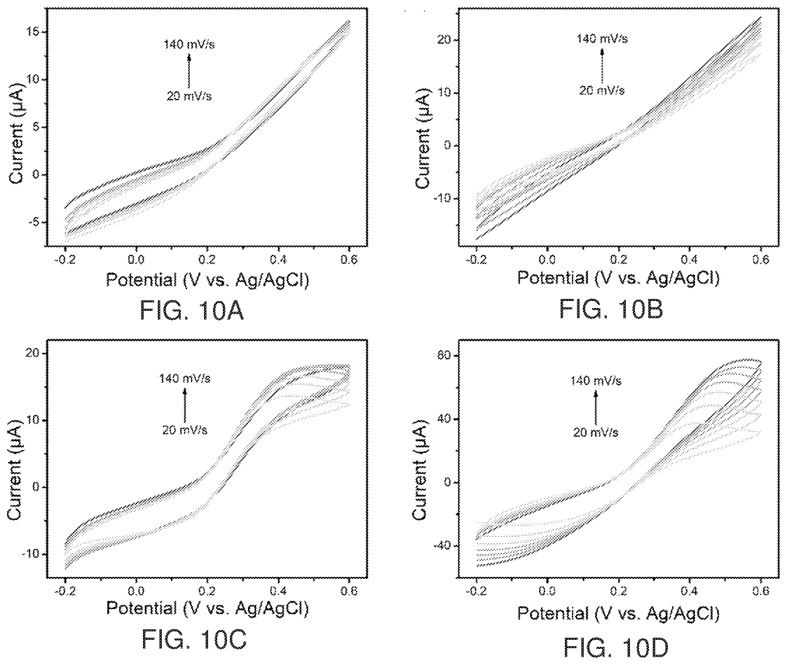

The surface wettability of the catalyst may influence the catalytic reaction in the liquid electrolyte. Hydrophilic interface has a larger contact area with methanol molecules, which helps to accelerate their diffusion and adsorption. Here, UV/O₃ treatment was utilized to modify the ZnO film's surface hydrophilicity. UV/O₃ exposure can introduce oxygen-containing functional groups onto the surface, enhancing the wettability of the interface. In order to investigate the effect of UV-O₃ treatment on piezo-electrocatalysis, ZnO NSs and NRs samples were treated with UV/O₃ for 10 to 60 seconds, respectively. In a specific example, the UV/O₃ treatment was applied using a UV Ozone Cleaner, commercially available from Ossila™. The UV/O₃ treatment includes utilizing a high-intensity UV light source, which illuminates the surface to be cleaned with two specific wavelengths of light. Low pressure mercury vapor discharge lamps are typically used, like the synthetic quartz UV grid lamp in the Ossila UV Ozone Cleaner, which have two dominant emission peaks at around 184 nm and around 254 nm. Upon irradiation, molecular oxygen present in the air is dissociated by radiation below 200 nm in length. This results in the formation of two radicals of oxygen. These radicals go on to react with further molecular oxygen forming molecules of ozone. At substantially the same time, light at 254 nm is used to excite organic species present on the surface of the sample. This process increases the reactivity of the contaminants with ozone. Upon reacting, the material is cleaned from the surface. The water contact angle (WCA) tests of the UV/O₃ treated ZnO samples revealed that the wettability of ZnO NSs and NRs samples is significantly enhanced as the treatment period increases, as shown in FIG. 3(a). This dry treatment made ZnO samples highly hydrophilic in only tens of seconds, which is faster and more convenient than known wet chemical treatment methods. By measuring CV in 1.0 mM electroactive [Fe(CN)₆]^{3-/4-} solution at 25° C., electrochemically active surface areas were estimated for different samples (with and without UV/O₃ treated deformed ZnO NRs or NSs), as shown in FIG. 10. As shown in FIG. 4, the linear relationship plots of the peak current (iₚ) versus the square root of the scan rate indicate the ion diffusivity in [Fe(CN)₆]^{3-/4-}, and the electrochemically active surface areas can be evaluated by the Randles-Sevcik equation.

i=2.69×10⁵n ^{3/2}AD^{1/2}Cv^{1/2}

Here, n represents the number of transferred electrons in the redox reaction, A is the electrode area in cm², D is the diffusion coefficient, C is the concentration in mM, and v is the scan rate in V·s⁻¹. The electroactive surface area of ZnO NRs treated with UV-O₃ (0.13 cm²) was calculated by the slop of the iₚ-v^{1/2} plot, which is about 5.9 times larger than the untreated ZnO NRs (0.022 cm²). Meanwhile, the surface area of the NSs treated with UV-O₃ (0.78 cm²) is 8.4 times larger than that of untreated NSs (0.092 cm²). The results revealed that the UV-O₃ treatment could improve the interface wettability and electrolyte permeability, resulting in a broader contact area between the catalyst and electrolyte, which increases the MOR reaction space compared to the untreated sample.

To further examine the influence of UV-O₃ treatment on the enhanced MOR activity, LSV measurements were performed on deformed ZnO samples subjected to various UV-O₃ treatment periods in 0.1 M KOH with or without methanol. With an increase in UV-O₃ exposure period, the change in current density increases sequentially from 10 s to 40 s and reaches the maximum at 40 s, as shown in FIGS. 3c and 3d. The increase in current density from 10 to 40 s of UV-O₃ treatment and the decrease in current density from 40 to 60 s of UV-O₃ treatment suggest a competing effect between wettability and oxygen vacancies in ZnO. For 10-40 s of UV-O₃ treatment, the catalytic efficiency of methanol is mainly affected by the wettability and enhanced with increasing interfacial wettability. During methanol catalysis, methanol molecules prefer to attach to the oxygen vacancies-rich catalyst. With a further increase in processing time, O₃ plasma may occupy more oxygen vacancies, resulting in a continuous decrease in charge transfer between Zn atoms and methanol molecules around the oxygen vacancy. The results showed that UV-O₃ processing time of 40 s can effectively enhance the MOR performance of ZnO piezo-electrocatalysts.

By introducing various radical scavengers to an experiment involving free radical tapping, the active species in piezo-electrocatalytic MOR were clarified. Disodium ethylene diamine tetraacetate dehydrates (EDTA-2Na), tert-butyl alcohol (TBA), and Benzoquinone (BQ) was utilized to scavenge holes (h⁺), hydroxyl (·OH) and superoxide radical (·O₂⁻, respectively. As shown in FIG. 4(a), these radical scavengers significantly suppressed the catalytic activity of ZnO catalysts, indicating that holes, ·OH, and ·O₂⁻, are the main active species in the piezo-electrocatalytic methanol oxidation process. These findings also demonstrated that ZnO NSs and NRs enabled the in-situ generation of ·O₂⁻, ·OH and holes further react with methanol molecules and initiate catalysis. The piezo-electrocatalytic methanol oxidation process is shown in FIG. 4(d). Because the conduction band (CB) bottom of ZnO (−0.31 V) is more negative than the standard redox potential of O₂/·O₂⁻ (−0.29 V), electrons in CB of ZnO can reduce dissolved O₂ into ·O₂⁻. In addition, the valence band (VB) top of ZnO (+2.89 V) is higher than the OH⁻/·H standard redox potential (+1.91 V), so holes can be transferred into the electrolyte, resulting in the oxidation of OH⁻ in the solution to ·OH radicals. The applied force can deform ZnO NSs and NRs, generating a piezoelectric potential along the surface (FIGS. 4(b, c)). Under the piezoelectric potential and electro-excitation, the bands of ZnO are tilted, as shown in FIG. 4(d), resulting in the generation of more radicals, thereby accelerating the MOR. The slope of the tilted bands is proportional to the magnitude of the piezoelectric potential. This increased redox process occurs in ZnO materials regardless of the applied force's direction. Therefore, a larger piezoelectric potential can facilitate the generation of ·O₂⁻ and ·OH radicals, resulting in enhanced methanol oxidation performance. Meanwhile, piezoelectric ZnO catalysts may participate in electrocatalytic MOR via strain-modulated piezo-electrocatalytic process, thus advantageously avoiding the limitations of conventional catalysts such as oxidation, reduction, decomposition, or poisoning.

Desirably, leveraging the piezo-electrocatalytic process, ZnO nanostructures with treatment and strain engineering can boost the electrocatalytic MOR performance by harvesting the otherwise wasted environmental mechanical energy. ZnO is inexpensive and abundant in the earth's crust. Hence the price of ZnO catalysts is significantly less than that of commercial Pt/C, as shown in Table 1 on the following page. The enhanced MOR performance of deformed ZnO nanomaterial can be related to the synergy between electrocatalysis and the piezoelectric effect. Specifically, the nanostructured ZnO NSs and NRs contain a large number of active surface sites to accelerate interface reactions. In addition, the presence of piezoelectric charges in ZnO can effectively alter its electronic structure, which not only induces the generation of radicals at the surface of NSs and NRs to significantly improve the kinetics of the MOR reaction but also militates against the catalyst from being oxidized, reduced, decomposed, or poisoned. In addition, the UV-O₃ treatment advantageously results in a hydrophilic surface, a larger surface area in contact with the electrolyte, and shorter ion diffusion routes, which effectively promotes the electrochemical process.

TABLE 1
Comparison of price and catalytic
performance of different catalysts

| | | Catalytic |
|---|---|---|
| Catalysts | Price | performance |
| Deformed ZnO | $ 0.0354 - 0.215/g* | 695 mV/dec |
| Nanorods | | |
| Deformed ZnO | $ 0.0354 - 0.215/g* | 774 mV/dec |
| Nanosheets | | |
| Pt/C | $ 125/g* | 110 mV/dec |

*The price of NRs refers to the prices of the following raw materials: Zn(OOCCH₃)₂•2H₂O ($ 0.00857/g), Zn(NO₃)₂•6H₂O ($ 0.0334/g), HMTA ($ 0.0511/g). The price of NSs refers to the prices of the following raw materials: Zn(OOCCH₃)₂•2H₂O ($ 0.00857/g), ZnCl₂ ($ 0.0166/g), KCl ($ 0.00742/g). The reference price of Pt/C catalyst is the commercial price.

### EXAMPLE

Provided as non-limiting examples, the electrocatalyst system of the present disclosure may be manufactured from various materials. For instance, indium tin oxide coated polyethylene terephthalate film (ITO-PET), surface resistivity 60 Ω/sq, was obtained from Sigma-Aldrich Zinc nitrate hexahydrate (Zn(NO₃)₂·6H₂O, 99.0%), zinc acetate dihydrate (Zn(OOCCH₃)₂·2H₂O, >99.0%) and HMTA (>99.0%) was purchased from Alfa Aesar. Other chemicals were supplied from VWR Analytical. One skilled in the art may select other suitable materials, within the scope of the present disclosure.

As a non-limiting example, zinc oxide nanosheets (ZnO NSs) and nanorods (ZnO NRs) were synthesized using a hydrothermal method. First, a ZnO seed layer was synthesized on a clean substrate by immersing the ITO-PET substrate five times in an ethanol solution containing 10 mM Zn(OOCCH₃)₂·2H₂O for 10 s, annealing at 85° C., and finally annealing at 250° C. for 20 min The substrates coated with ZnO seed layer were then immersed in a nanorod growth solution containing 10 mM Zn(NO₃)₂·6H₂O and 10 mM HMTA, and a nanosheet growth solution containing 20 mM zinc chloride (ZnCl₂) and 20 mM potassium chloride (KC1), respectively, and reacted at 80° C. for 6 h. Finally, ZnO NSs and NRs coated ITO-PET substrates were obtained after repeated rinsing. Then, the ITO-PET substrates loaded with ZnO nanomaterials were placed in ultraviolet ozone (UV-O₃, Jelight-Model 18) cleaning machine for 40 seconds. It should be appreciated the temperatures, durations, and number of cycles are provided as non-limiting examples. A skilled artisan may use other methods for forming the ZnO NSs and NRs, within the scope of the present disclosure.

X-ray diffraction (XRD) data were recorded on Panalytical Empyrean Powder X-ray Diffractometer. A Hitachi S-4800 scanning electron microscope was used for field-emission scanning electron microscopies (FE-SEM) characterization. The surface roughness and thickness of the nanosheets were determined by an atomic force microscope (AFM, Key sight 5500). The interface wettability was tested by a static water contact angle (WCA) measurement (JC2000D1 Instrument).

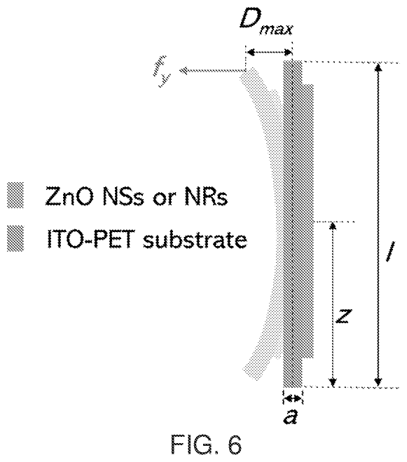

Flexible ITO-PET loaded with ZnO catalyst was bent through Kapton tape, and the bending curvature was estimated in FIG. 6. Since the dimensions of ZnO NRs (200 nm×2 μm) and NSs (1 μm×2 μm×(95-120 nm) are significantly smaller than those of the ITO-PET substrates, the mechanical behavior of the substrate is not affected by the ZnO nanomaterials. Consequently, a simple estimation of the strain induced in ZnO/ITO-PET can be obtained by the Saint-Venant theory for small bending deformation. As shown in Figure S2, the ITO-PET substrate can be approximated as a beam structure with thickness a, width w, and length l, and the origin for calculation is defined as the center of the bottom edge. The x and z axes are along the width (w) and length (l) directions of the substrate, respectively. If slip is not considered, the deflection of the substrate will lead to pure elongation or contraction in the NSs or NRs under an external force f_{y}. It can be seen that the uniaxial in-plane strain induced by the ZnO material can be estimated by the E_{zz} component of the strain in the ITO-PET substrate. For the beam, applying Saint-Venant's theory, σ_{z}z=−(f_{y}Iₓₓ)y(l−z), σₓₓ=σ_{yy}=0, where Iₓₓ is the moment of inertia of the beam. Therefore, ϵ_{zz}=σ_{zz}/E, where E is the Young's modulus of the ITO-PET substrate. Experimentally, it is easier to measure the lateral deflection Dmax of the free end of the substrate than to measure the external force f_{y}. Since Dₘₐₓ=f_{y}l³/3EIₓₓ of classical beam mechanics, then

$${ε}_{ZZ} = - \frac{3 y}{l} \frac{{D}_{max}}{l} ( 1 - \frac{z}{l} )$$

The NSs and NRs are assumed to be located at y=±a/2 and z=z₀, where z₀ is the distance from the bottom edge to the ZnO material, which can be measured experimentally, so the strain of the ZnO materials can be estimated by

$$ε = {ε}_{ZZ} = ∓ 3 \frac{a}{2 l} \frac{{D}_{max}}{l} ( 1 - \frac{{z}_{0}}{l} )$$

The negative sign represents compressive strain and the positive sign represents tensile strain. All variables in the above equation can be easily measured experimentally.

The deformed ZnO materials in this work are all under 0.4% strain. The electrochemical tests mentioned were all carried out with the traditional three-electrodes system of the electrochemical workstation (CHI-660E), as shown FIG. 2(a). The as-prepared ZnO/ITO-PET electrode was used as a working electrode, with a Pt sheet as the counter electrode and an Ag/AgCl (3.3 M KCl) electrode as the reference electrode. To explore piezoelectric effect enhanced MOR activity, linear sweep voltammetry (LSV) and cyclic voltammetry (CV) were carried out in 0.5 M methanol/0.1 M KOH solution. Electrochemical impedance spectroscopy (EIS) analysis of these catalysts was tested at 0.50 V. In order to explore the stability of MOR, the chronoamperometry (CA) measurement was performed in 0.5 M methanol/0.1 M KOH solution at 0.50 V.

### Description Continued:

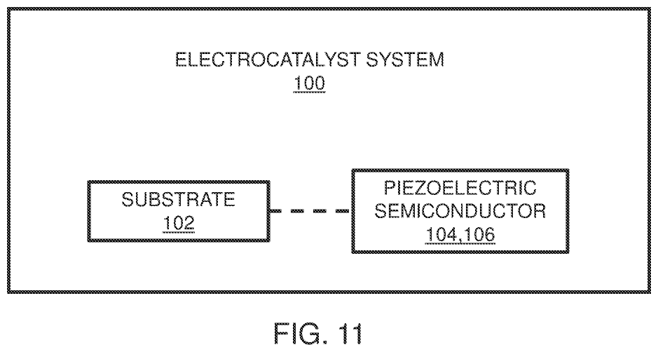

As shown in FIG. 11, the electrocatalyst system 100, configured to oxidize methanol molecules using piezo-electrocatalysis, includes a substrate 102 and a piezoelectric semiconductor 104,106. The piezoelectric semiconductor 104,106 may be coupled to the substrate 102. The piezoelectric semiconductor 104,106 may include a nanostructured semiconducting zinc oxide (ZnO) catalyst. The nanostructured semiconducting zinc oxide catalyst 104,106 may be treated with UV-ozone (UV-O3). The piezoelectric semiconductor 104,106 may facilitate a charge transfer between a mechanically deformed ZnO nanostructure 104,106 and the methanol molecules. In a specific example, the electrocatalyst system 100 may be provided in a methanol fuel cell.

In certain circumstances, the nanostructured semiconducting ZnO catalyst 104,106 may have a noncentrosymmetric wurtzite configuration. The noncentrosymmetric wurtzite configuration may include a crystal formation with hexagonal symmetry. In a specific example, the nanostructured semiconducting ZnO catalyst 104,106 may be provided as a ZnO nanorod 104. The ZnO nanorod 104 may have a terminal end connected to the substrate 102. The ZnO nanorod 104 may have a substantially hexagonal cross-section. In another specific, non-limiting example, the nanostructured semiconducting ZnO catalyst 104,106 may be provided as a ZnO nanosheet 106. A skilled artisan may select other suitable shapes and formations of the ZnO catalyst 104,106, within the scope of the present disclosure.

In certain circumstances, the substrate 102 may be provided in various ways. For instance, the substrate 102 may be constructed from a conductive material, such as a metal material and/or graphite. In a more specific example, the substrate 102 may include an indium tin oxide substrate 102. In an even more specific example, the substrate 102 may include an indium tin oxide coated polyethylene terephthalate film. One skilled in the art may select other suitable materials to form the substrate 102, within the scope of the present disclosure.

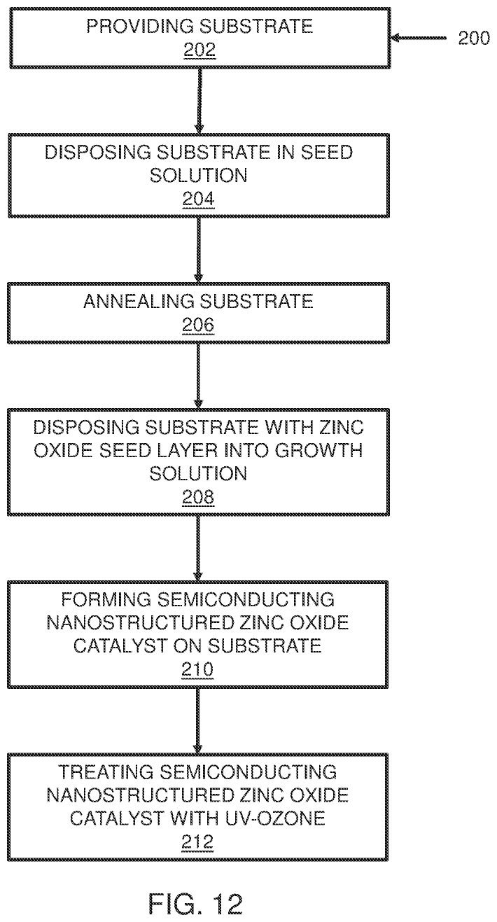

Various ways of manufacturing the electrocatalyst system 100 are provided. For instance, as shown in FIG. 12, a method 200 may include a step 202 of providing a substrate 102. The substrate 102 may be constructed from a conductive material, such as a metal material and/or graphite. In a more specific example, the substrate 102 may include an indium tin oxide substrate. In an even more specific example, the substrate 102 may include an indium tin oxide coated polyethylene terephthalate film. Next, the method 200 may include a step 204 of disposing the substrate 102 in a seed solution. It is also contemplated for the seed solution to be disposed onto the substrate 102. The seed solution may include a zinc salt such as zinc acetate, zinc nitrate, and/or zinc chloride. In a more specific example, the seed solution may include zinc acetate dihydrate. The seed solution may be configured to produce a ZnO seed layer on the substrate 102. In some circumstances, the method 200 may include a step 206 of annealing the substrate 102. In a specific example, the substrate 102 may be annealed at around eight-five degrees Celsius. In a more specific example, the substrate 102 may be disposed in the seed solution and annealed multiple times. In an even more specific example, the substrate 102 may undergo a final annealing cycle at around two-hundred fifty degrees Celsius for around twenty minutes. After the substrate 102 is annealed, a ZnO seed layer may be coupled to the substrate 102. Then, the substrate 102 with the ZnO seed layer may be disposed into a growth solution. The growth solution may be configured to form a semiconducting nanostructured ZnO catalyst 104,106 on the substrate 102. In a specific example, the growth solution may include zinc nitrate and/or hexamethylenetetramine to form ZnO NRs 104. In a separate, specific example, the growth solution may include zinc chloride and potassium chloride to form ZnO NSs 106. Afterwards, the semiconducting nanostructured ZnO catalyst 104,106 disposed on the substrate 102 may be treated with a UV-ozone (UV-O3), thereby manufacturing the electrocatalyst system 100. In a specific example, the step 212 of treating the semiconducting nanostructured zinc oxide catalyst with UV-ozone may include utilizing a first wavelength of light below 200 nm and a second wavelength of light greater than 200 nm. One skilled in the art may select other suitable ways to manufacture the electrocatalyst system 100, within the scope of the present disclosure.

Advantageously, the electrocatalyst system 100 has enhanced efficiency over known electrocatalyst devices by elucidating the charge transfer between mechanically-deformed ZnO nanostructures 104,106 and methanol molecules. Desirably, the electrocatalyst system 100 may be easily and more economically manufactured than known electrocatalyst devices.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. An electrocatalyst system configured to oxidize a methanol molecule using piezo-electrocatalysis, wherein the electrocatalyst system comprises:
a substrate; and
a piezoelectric semiconductor coupled to the substrate, wherein the piezoelectric semiconductor includes a nanostructured semiconducting zinc oxide catalyst;
wherein the nanostructured semiconducting zinc oxide catalyst is treated with UV-ozone (UV-O₃).

2. The electrocatalyst system of claim 1, wherein a surface of the piezoelectric semiconductor is hydrophilic.

3. The electrocatalyst system of claim 2, wherein the hydrophilic surface has oxygen-containing functional groups.

4. The electrocatalyst system of claim 1, wherein the nanostructured semiconducting ZnO catalyst has a noncentrosymmetric wurtzite configuration.

5. The electrocatalyst system of claim 4, wherein the noncentrosymmetric wurtzite configuration includes a crystal formation with hexagonal symmetry.

6. The electrocatalyst system of claim 1, wherein the nanostructured semiconducting ZnO catalyst is provided as a ZnO nanorod.

7. The electrocatalyst system of claim 1, wherein the nanostructured semiconducting ZnO catalyst is provided as a ZnO nanosheet.

8. The electrocatalyst system of claim 1, wherein the substrate is constructed from a conductive material.

9. The electrocatalyst system of claim 8, wherein the substrate includes indium tin oxide.

10. The electrocatalyst system of claim 9, wherein the substate includes an indium tin oxide coated polyethylene terephthalate film.

11. The electrocatalyst system of claim 1, wherein the piezoelectric semiconductor facilitates a charge transfer between a mechanically deformed ZnO nanostructure and the methanol molecule.

12. The electrochemical system of claim 1, wherein the piezoelectric semiconductor is hydrothermally synthesized to the substrate.

13. A methanol fuel cell including the electrocatalyst system of claim 1.

14. A method of manufacturing an electrocatalyst system configured to oxidize methanol using piezo-electrocatalysis, the method comprising the steps of:
providing a substrate;
disposing the substrate in a seed solution including zinc, the seed solution is configured to produce a zinc oxide seed layer on the substrate;
disposing the substrate with the zinc oxide seed layer into a growth solution, the growth solution is configured to form a semiconducting nanostructured zinc oxide catalyst on the substrate;
forming a semiconducting nanostructured zinc oxide catalyst on the substrate; and
treating the semiconducting nanostructured zinc oxide catalyst with UV-ozone (UV-O₃).

15. The method of claim 14, wherein the seed solution includes a zinc salt.

16. The method of claim 16, wherein the seed solution includes at least one of zinc acetate, zinc nitrate, and zinc chloride.

17. The method of claim 14, further comprising a step of annealing the substrate after the step of disposing the substrate in a seed solution but before the step of disposing the substrate with the zinc oxide seed layer into the growth solution.

18. The method of claim 14, wherein the growth solution includes at least one of zinc nitrate and hexamethylenetetramine.

19. The method of claim 14, wherein the growth solution includes at least one of zinc chloride and potassium chloride.

20. The method of claim 14, wherein the step of treating the semiconducting nanostructured zinc oxide catalyst with UV-ozone includes utilizing a first wavelength of light below 200 nm and a second wavelength of light greater than 200 nm.
